(19) United States
(12) Patent Application Publication
(10) Pub. No.: US 2013/0086243 A1
(43) Pub. Date: Apr. 4, 2013

(54) APPARATUS AND METHOD FOR INTEGRALLY MANAGING MAINTENANCE OF ELECTRONIC DEVICES

(71) Applicant: Samsung Electronics Co., Ltd., Gyeonggi-do (KR)

(72) Inventors: Hyung Rae CHO, Seoul (KR); Ji Hyeon Kweon, Gyeonggi-do (KR); Seok Min Oh, Gyeonggi-do (KR); Kang Min Lee, Gyeonggi-do (KR); Yousef Kharsim, Gyeonggi-do (KR)

(73) Assignee: Samsung Electronics Co., Ltd., Gyeonggi-so (KR)

(21) Appl. No.: 13/627,369

(22) Filed: Sep. 26, 2012

(30) Foreign Application Priority Data
Sep. 30, 2011 (KR) 10-2011-0100302

(51) Int. Cl. G06F 15/173

(52) U.S. Cl. 709/223

(57) ABSTRACT

An apparatus and a method for integrally managing maintenance of a plurality of electronic devices are provided, where the device management system includes a server that stores maintenance packages; a plurality of electronic devices that execute maintenance; and a device management apparatus that acquires a plurality of maintenance packages with respect to the plurality of electronic devices from the server, generates a general maintenance schedule including at least one maintenance execution time with reference to the plurality of maintenance packages, and executes maintenance of an electronic device from among the plurality of electronic devices corresponding to the at least one maintenance execution time, when the at least one maintenance execution time arrives.

### PRIORITY

This application claims priority under 35 U.S.C. §119(a) to Korean Patent Application No. 10-2011-0100302, which was filed in the Korean Intellectual Property Office on Sep. 30, 2011, the entire disclosure of which is hereby incorporated by reference.

### BACKGROUND OF THE INVENTION

1. Field of the Invention

The present invention relates generally to a device management apparatus, a mobile terminal, and a server connected to each other through a network, and more particularly, to an apparatus and method for integrally managing maintenance of a plurality of electronic devices through a network.

2. Description of the Related Art

Using network technology, a plurality of electronic devices may be operated and maintenance work thereon may be performed via remote control through a network. For example, a device management apparatus connected to the Internet can manage information communication for maintenance work between a server, e.g., a web server, and an electronic device. Examples of maintenance work include software updates, automatic synchronization of digital content or an address book, and remote diagnostic for repairs.

Typically, a plurality of electronic device connected to the device management apparatus through the network are used at the same time. However, if maintenance is occurring in any one of electronic devices, the user cannot use the electronic device during the maintenance. Further, if maintenance is occurring in any one of electronic device the user cannot use other electronic devices in electronic device connected to the device management apparatus through the network or should inevitably use other electronic devices disconnected from the network.

Further, because it is currently difficult to estimate time required for performing maintenance of the electronic devices, it may be inconvenient to use electronic devices. Accordingly, there is an essential need to manage maintenance work schedules of the electronic devices.

Further, there is a demand to associate maintenance works of electronic devices. For example, even after maintenance of a certain electronic device is completed, if maintenance is then required for an electronic device to be used simultaneously or as a substitute is performed, inconvenience of the user in using the electronic devices may become double.

However, a memory capacity of a current electronic device is small, making it difficult to manage maintenance of other electronic devices connected to a device manger through a network.

### SUMMARY OF THE INVENTION

The present invention has been designed to address at least the above-identified problems occurring in the prior art, and to provide at least the advantages described below.

Accordingly, an aspect of the present invention is to provide an apparatus and a method for integrally managing maintenance of a plurality of electronic devices connected to a device management apparatus through a network.

Another aspect of the present invention is to provide an apparatus and a method for integrally managing maintenance of electronic devices capable of automatically performing maintenance for a plurality of electronic devices.

Another aspect of the present invention is to provide an apparatus and a method for automatically performing maintenance of electronic devices, when a user does not use the electronic devices.

Another aspect of the present invention is to provide an apparatus and a method for performing maintenance without interrupting use of electronic devices.

Another aspect of the present invention is to provide an apparatus and a method for integrally managing maintenance of electronic devices capable of remote support, such that a software version management may be performed.

In accordance with an aspect of the present invention, a method for integrally managing maintenance of a plurality of electronic devices by a device management apparatus is provided. The method includes acquiring, by the device management apparatus, a plurality of maintenance packages for the plurality of electronic devices; generating a general maintenance schedule including at least one maintenance execution time with reference to the plurality of maintenance packages; and upon arrival of the at least one maintenance execution time, transmitting a maintenance package and a maintenance control signal to a corresponding electronic device from among the plurality of electronic devices according to the general maintenance schedule.

In accordance with another aspect of the present invention, a device management system is provided. The system includes a server that stores maintenance packages; a plurality of electronic devices that execute maintenance; and a device management apparatus that acquires a plurality of maintenance packages with respect to the plurality of electronic devices from the server, generates a general maintenance schedule including at least one maintenance execution time with reference to the plurality of maintenance packages, and executes maintenance of an electronic device from among the plurality of electronic devices corresponding to the at least one maintenance execution time, when the at least one maintenance execution time arrives

In accordance with another aspect of the present invention, a device management apparatus is provided. The device management apparatus includes a device management communication unit that acquires and transfers a plurality of maintenance packages with respect to a plurality of electronic devices; a device management memory storing the plurality of maintenance packages; and a device management controller generating a general maintenance schedule including at least one maintenance execution time with reference to the plurality of maintenance packages, and transmitting a maintenance package and a maintenance control signal to a corresponding electronic device from among the plurality of electronic devices according to the general maintenance schedule

In accordance with another aspect of the present invention, a mobile terminal is provided. The mobile terminal includes a communication unit that communicates with a device management apparatus; a display unit that displays a graphic user interface for integrally managing maintenance of a plurality of electronic devices connected to the device management apparatus; and a controller that controls the device management communication unit to collect maintenance relation data with at least one of the plurality of electronic devices, and controls the display unit to display the maintenance relation data and the graphic user interface

### BRIEF DESCRIPTION OF THE DRAWINGS

The above and other aspects, features, and advantages of certain embodiments the present invention will be more apparent from the following detailed description in conjunction with the accompanying drawings, in which:

FIG. 1 illustrates a system for integrally managing maintenance of electronic devices according to an embodiment of the present invention;

FIG. 2 is a signal flow diagram illustrating a method of integrally managing maintenance of electronic devices in a device management system according to an embodiment of the present invention;

FIG. 3 is a flowchart illustrating a method of integrally managing maintenance of electronic devices by a device management apparatus in a device management system according to an embodiment of the present invention;

FIG. 4 is a timing chart illustrating an example of a driving pattern of a television and a general maintenance schedule for a television according to an embodiment of the present invention;

FIG. 5 is a timing chart illustrating an example of a driving pattern of electronic devices whose maintenance work may be performed in the day and a general maintenance schedule according to an embodiment of the present invention;

FIG. 6 is a signal flow diagram illustrating a procedure of adjusting a general maintenance schedule when interference occurs due to a request of a mobile terminal during a maintenance work according to an embodiment of the present invention;

FIG. 7 is a signal flow diagram illustrating a procedure of adjusting a general maintenance schedule when interference is detected from a remote controller or an input unit in an electronic device during a maintenance work according to an embodiment of the present invention;

FIG. 8 is a timing chart illustrating a general maintenance schedule, an actual used time of a television, an interference signal, and an interference release signal for a television indicating an example of adjusting a general maintenance schedule during interference of maintenance according to an embodiment of the present invention;

FIG. 9 is a block diagram illustrating a device management apparatus according to an embodiment of the present invention;

FIG. 10 is a block diagram illustrating a controller of a device management apparatus according to an embodiment of the present invention;

FIG. 11 illustrates a Graphic User Interface (GUI) for displaying a maintenance execution state according to an embodiment of the present invention; and

FIG. 12 illustrates a GUI for supporting a version restoration function according to an embodiment of the present invention.

### DETAILED DESCRIPTION OF EMBODIMENTS OF THE INVENTION

Various embodiments of the present invention are described in detail below with reference to the accompanying drawings. The same reference numbers are used throughout the drawings to refer to the same or like parts. Additionally, detailed descriptions of well-known functions and structures incorporated herein are omitted to avoid obscuring the subject matter of the present invention in unnecessary detail.

In a device management system according to an embodiment of the present invention, electronic devices are connected to a device management apparatus in wired/wireless schemes, and the device management apparatus is connected to a mobile terminal in wired/wireless schemes. Accordingly, if a user of the mobile terminal selects execution of power on/off and various functions of electronic devices, an execution command is transferred to a corresponding device through the device management apparatus, such that a corresponding electronic device may operate according to the execution command. Accordingly, the user can operate various electronic devices using the mobile terminal. For example, the electronic devices may include a television, a refrigerator, a washing machine, a microwave oven, etc.

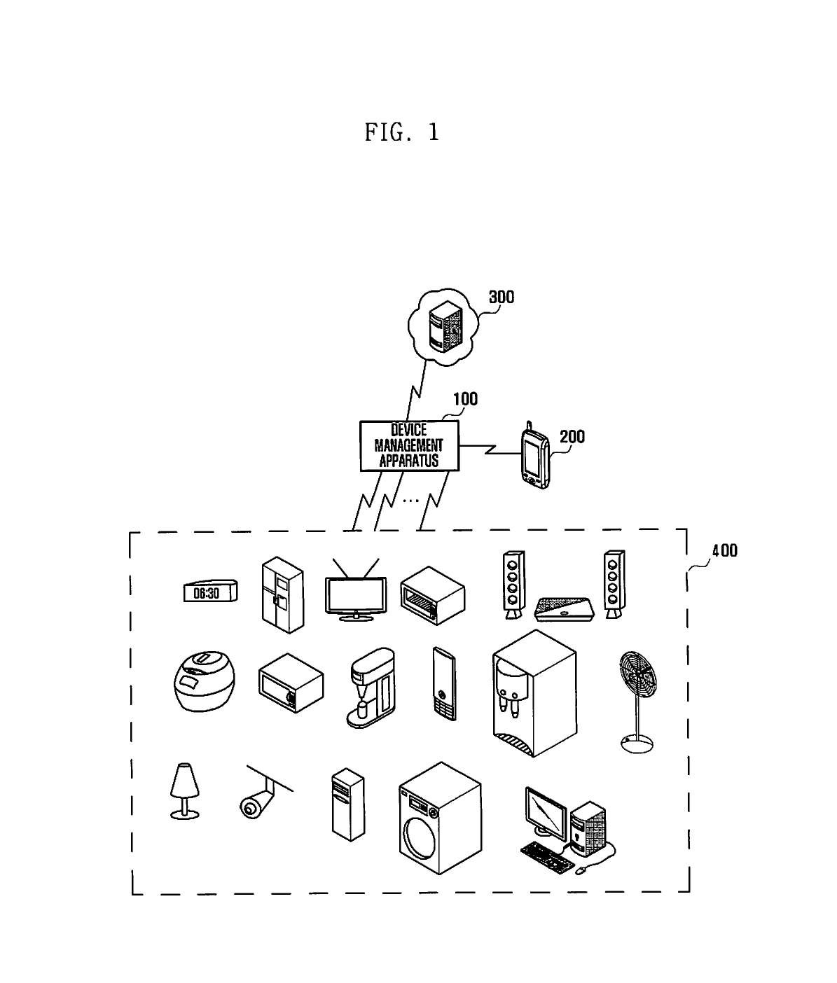

FIG. 1 illustrates a device management system according to an embodiment of the present invention.

Referring to FIG. 1, the device management system includes a device management apparatus 100, a mobile terminal 200, a maintenance server 300, and a plurality of electronic devices 400. The device management apparatus 100 controls the plurality of electronic devices 400, and stores identification information, driving patterns, and software versions of the plurality of electronic devices 400 connected thereto. Further, the device management apparatus 100 plans maintenance for the plurality of electronic devices 400 and supports such the maintenance according to the planning.

For example, the mobile terminal 200 may be a smart phone or a tablet Personal Computer (PC). The mobile terminal 200 is located within a predetermined radius from the device management apparatus 100 and communicates with the device management apparatus 100. The mobile terminal 200 receives user input through a GUI and remotely controls certain electronic devices connected to the device management apparatus 100. Specifically, the mobile terminal 200 provides a GUI that allows a user to manage maintenance of the plurality of electronic devices 400. For example, the mobile terminal 200 outputs a maintenance state of the plurality of electronic devices 400 to inform the user, and displays a software version history associated with each of the plurality of electronic devices 400.

The maintenance server 300 transmits a maintenance package of a plurality of electronic devices 400 to the device management apparatus 100 in response to a request from the device manger 100 or in accordance with a push scheme of the maintenance server 300. The maintenance server 300 stores the maintenance package, identification, and address information of the device management apparatus 100, and identification information of a plurality of electronic devices 400 connected to the device management apparatus 100. Accordingly, the maintenance server 300 can transmit maintenance packages for various maintenance, such as software updates, digital content, automatic synchronization of an address book, remote diagnosis, etc., to the device management apparatus 100 connected to a corresponding electronic device 400. The maintenance package includes identification information, address information, and maintenance data of a corresponding electronic device for maintenance. For example, the maintenance data is used during maintenance, and may include files or update commands that are added upon a software update, digital content, address book, and remote diagnosis commands for synchronization.

The plurality of electronic devices 400 are connected to the device management apparatus 400 in wired/wireless schemes, and may be remotely controlled. As illustrated in FIG. 1, examples of the plurality of electronic devices 400 include, but are not limited to, a television, a refrigerator, a home theatre system, a microwave oven, an electric cooker, a security camera, a door-lock system, a lamp, an air conditioner, a washing machine, a watch, a water purifier, a coffee maker, an electric fan, and a desktop computer.

In particular, the plurality of electronic devices 400 are characterized that maintenance thereof may be performed according to a maintenance control signal received from the device management apparatus 100. Accordingly, each of the plurality of electronic devices 400 include a wired and/or wireless module for communicating with the device management apparatus 100. For example, the plurality of electronic devices 400 may communicate in a Digital Living Network Alliance (DLNA) standard scheme, support connection with a ZigBee, a Z-Wave, an Ethernet, a WiFi, or a BlueTooth network, use Transmission Control Protocol/Internet Protocol (TCP/IP), and implement a HyperText Markup Language (HTML) and a Simple Object Access Protocol (SOAP) to transmit and manage digital content.

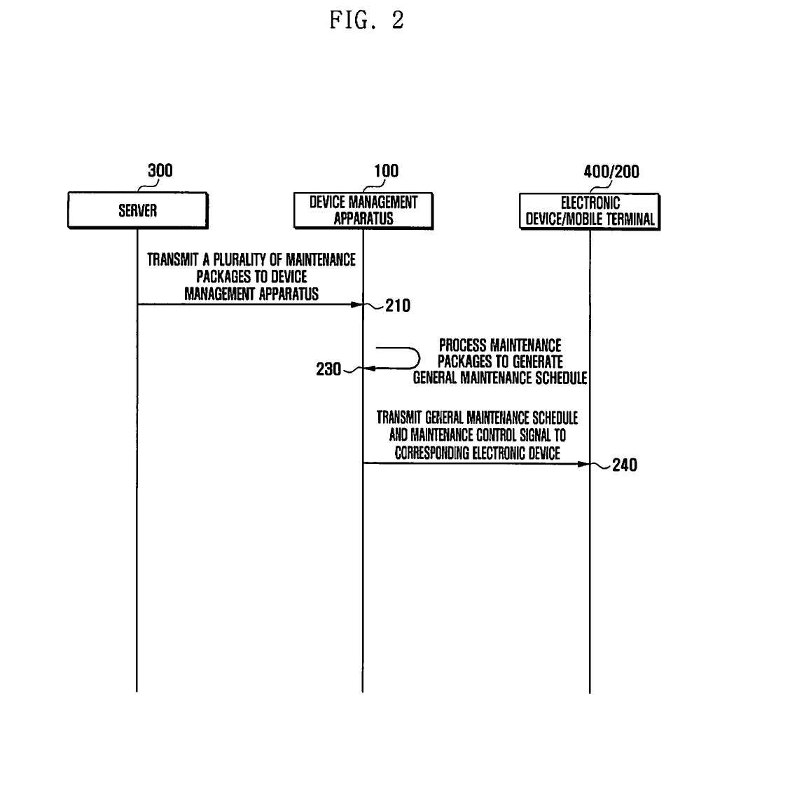

FIG. 2 is a signal flow diagram illustrating a method of integrally managing maintenance of electronic devices in a device management system according to an embodiment of the present invention.

Referring to FIG. 2, the maintenance server 300 transmits a plurality of maintenance packages to the device management apparatus 100 in step 210. For example, the maintenance server 300 may communicate the maintenance packages, after receiving a request from the device management apparatus 100 or according to a push scheme. Additionally, the maintenance server 300 may transmit the maintenance packages at one time, separately, or in groups.

After receiving the plurality maintenance packages, the device management apparatus 100 processes the maintenance packages to generate a general maintenance schedule in step 230.

In step 240, the device management apparatus 100 transmits the maintenance package and a maintenance control signal to a corresponding electronic device 400, according to a general maintenance schedule. For example, the package may be transmitted with a maintenance control signal in a streaming scheme. Here, the maintenance control signal is a signal for instructing a maintenance relation work, such as, start, stop, and restart.

Although FIG. 2 illustrates the maintenance packages being transferred with the maintenance control signal in step 240, the maintenance package may be transferred to a corresponding electronic device before the maintenance control signal is transmitted.

The device management apparatus 100 may also manage maintenance of the mobile terminal 200 by transferring packages with respect to update of an application program for managing a maintenance of the electronic devices 400, e.g., a GUI update for a general maintenance schedule and the maintenance control signal to the mobile terminal 200.

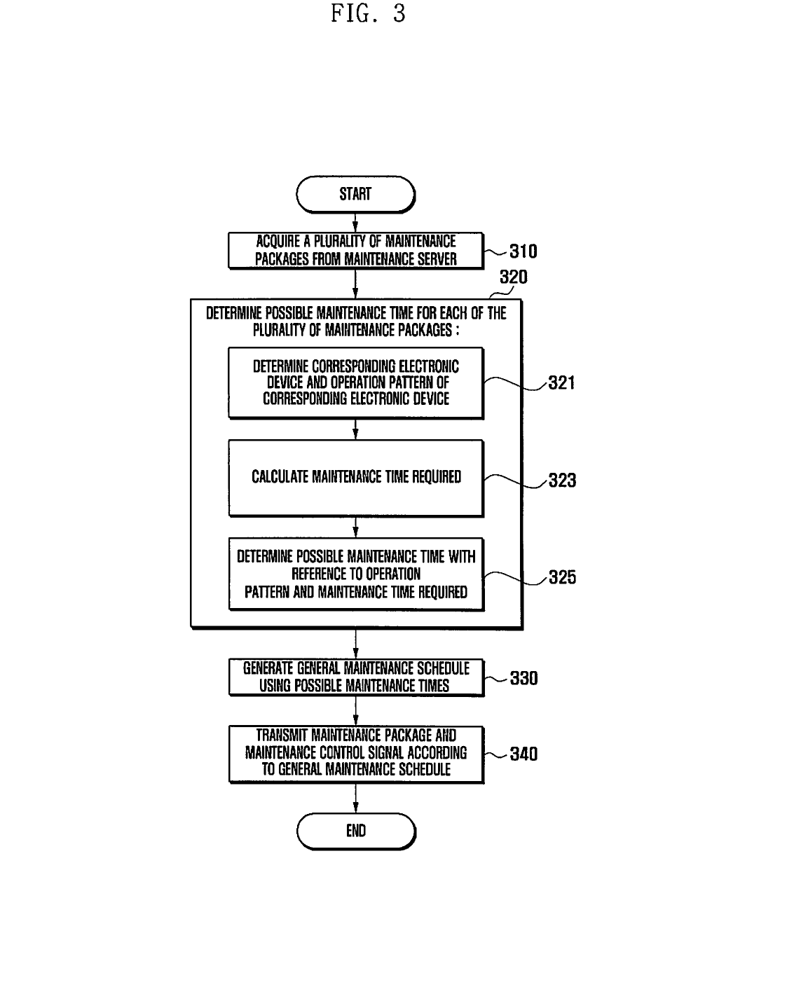

FIG. 3 is a flowchart illustrating a method of integrally managing maintenance of a plurality of electronic devices by a device management apparatus in a device management system according to an embodiment of the present invention.

Referring to FIG. 3, the device management apparatus 100 acquires a plurality of maintenance packages from a maintenance server 300 in step 310. As described above, the plurality of maintenance packages may be acquired at one time, acquired separately, or acquired by groups.

In step 320, the device management apparatus 100 processes a plurality of acquired maintenance packages. Specifically, the device management apparatus 100 determines a corresponding electronic device for each of a plurality of maintenance packages and a driving pattern of the corresponding electronic device in step 321. For example, the corresponding electronic device may be recognized with reference to identification information of a corresponding electronic device included in the package.

Further, the driving pattern is collected for each electronic device connected to the device management apparatus 100, and is stored in the device management apparatus 100. For example, the driving pattern may be a time pattern obtained by recording and monitoring power on/off times of an electronic device corresponding to the device management apparatus 100. That is, the driving pattern may designate power on/off times of the corresponding electronic device for each day of a week or for each time, and the driving pattern may be updated according to a predetermined period.

In step 323, after recognizing the corresponding electronic device and driving pattern, the device management apparatus 100 calculates a maintenance time required of the package in step 323. For example, the device management apparatus 100 may determine a required maintenance time in consideration of the size of the package and calculation processing speed of a corresponding electronic device. If the maintenance time is transferred to the corresponding electronic device with the maintenance control signal, namely, in a streaming scheme, the device management apparatus 100 may determine the required maintenance time in further consideration of communication speed with the corresponding electronic device.

In step 325, after calculating the required maintenance time, the device management apparatus 100 determines a possible maintenance time with reference to a driving pattern and the required maintenance time. Here, the possible maintenance time is a time interval during which maintenance may be performed, while power of the electronic device is turned-off. For example, the maintenance time required of a software update package of a television may be one hour.

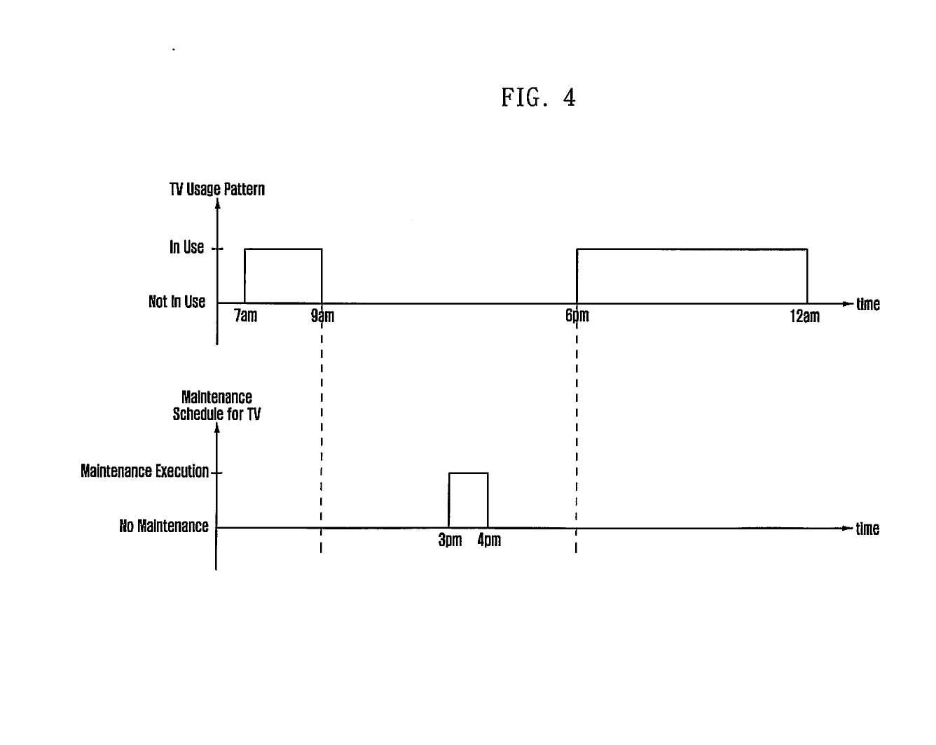

FIG. 4 is a timing chart illustrating an example of a driving pattern of a television and a general maintenance schedule for a television according to an embodiment of the present invention.

Referring to FIG. 4, a possible maintenance time in a timing chart of a television driving pattern is from 9 a.m. to 6 p.m. and from 12 a.m. to 7 a.m. Therefore, if the required maintenance time of the television is about 8 hours, the possible maintenance time may be adjusted between 9 a.m. to 6 p.m.

The device management apparatus 100 may perform step 321 to step 325 for each package as illustrated above. Accordingly, possible maintenance times of corresponding electronics of a plurality of packages are determined.

Referring again to FIG. 3, the device management apparatus 100 generates a general maintenance schedule using possible maintenance times in step 330. Here, the general maintenance schedule indicates a schedule in which maintenance of the electronic devices is performed. That is, the general maintenance schedule is a list of execution times of maintenance, either separately or in groups, with respect to the electronic devices. The execution time of the maintenance is a time interval planed such that a maintenance work is performed by the device management apparatus 100.

When generating the general maintenance schedule, the device management apparatus 100 may separately determine a schedule of the electronic devices. For example, referring again to FIG. 4, the device management apparatus 100 determines a maintenance schedule with respect to a television from 3 p.m. to 4 p.m. in consideration of a possible maintenance time.

The device management apparatus 100 may group the electronic devices and determine schedules of the electronic devices. Specifically, the electronic devices may be grouped according to a simultaneous power off time zone of the electronic devices.

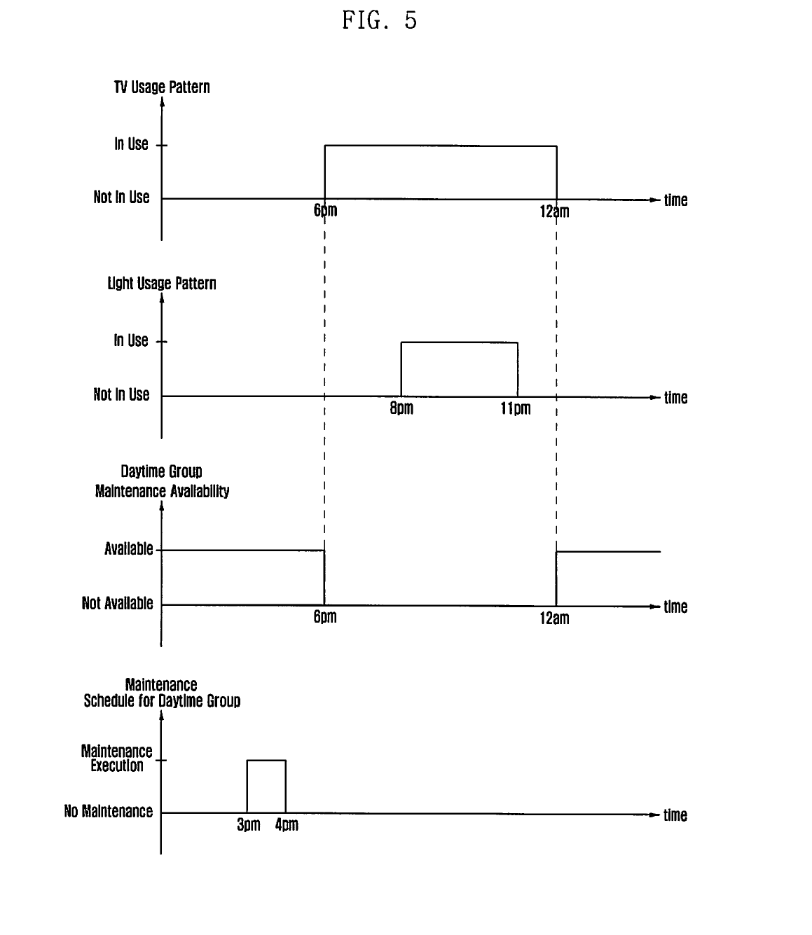

FIG. 5 is a timing chart illustrating an example of a driving pattern of electronic devices whose maintenance work may be performed in the day and a general maintenance schedule according to an embodiment of the present invention.

For example, referring to FIG. 5, the device management apparatus 100 determines that the electronic devices are mainly used in an evening time zone with reference to driving patterns of a television and indoor illumination system, and designates the television and the indoor illumination system as a group whose maintenance work should be performed in a day time zone. Further, the device management apparatus 100 may determine a possible maintenance time with a day time group.

Subsequently, the device management apparatus 100 plans a maintenance execution time of the day time group based on the longest time of the required maintenance time of electronic devices 400 included in the day time group. For example, when maintenance of a television will take longer than that of the indoor illumination system, the device management apparatus 100 plans a maintenance execution time as one hour from 3 p.m. to 4 p.m. according to a required maintenance time of the television as illustrated in FIG. 5. Accordingly, a maintenance execution time of a television of a day time group becomes from 3 p.m. to 4 p.m. and a maintenance execution time of an illumination may be any time during that time interval.

Further, the device management apparatus 100 generates general maintenance schedules of the electronic devices by groups according to a location and used applications of the electronic devices 400. For example, the electronic devices 400 may be grouped for each room according to an arranged space or may be grouped according to a predetermined activity of a user using electronic devices 400, such as for entertainment or food preparation.

Further, the device management apparatus 100 divides the plurality of electronic devices 400 into groups according to at least one of a driving pattern, a location, and a used application of the plurality of electronic devices 400.

As described above, a maintenance execution time may be managed for each group to suitably plan a used application of the plurality of electronic devices 400. Accordingly, the probability of interrupting a device being used by a user with the maintenance is minimized.

Referring again to FIG. 3, after generation the general maintenance schedule, the device management apparatus 100 transmits a maintenance package and a maintenance control signal to a corresponding electronic device according to a general maintenance schedule in step 340.

As described above, according to an embodiment of the present invention, a device management system integrally manages a maintenance schedule of a plurality of electronic devices 400 according to a driving pattern of a driving pattern of the plurality of electronic devices 400 connected to a device management apparatus 100. Therefore, according to an embodiment of the present invention, maintenance is performed at a time when a user is unlikely to use a device.

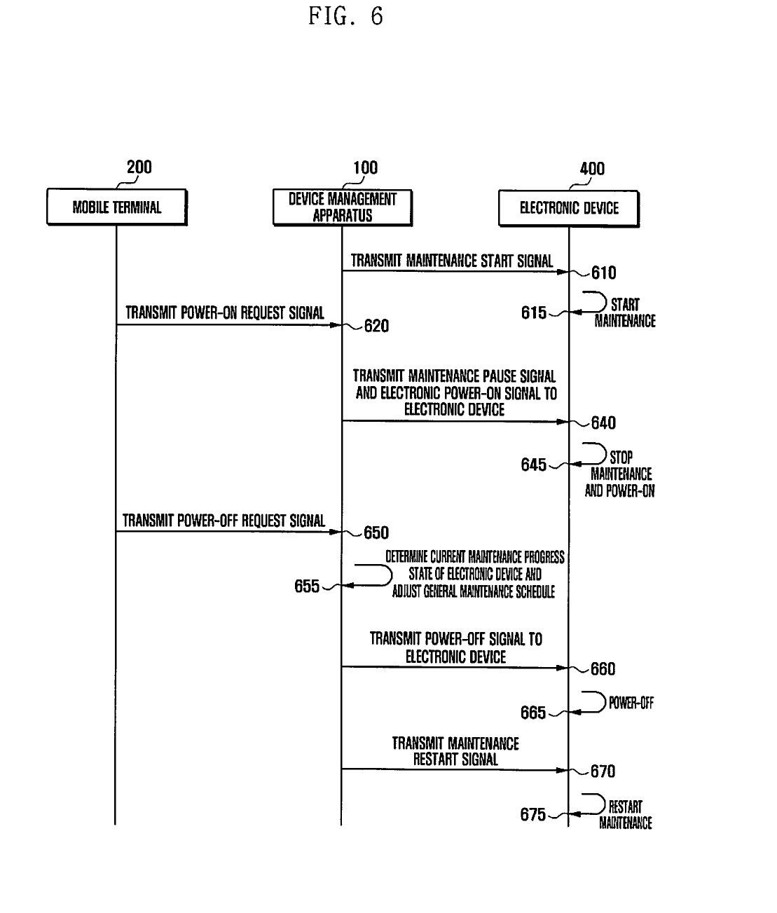

FIG. 6 is a signal flow diagram illustrating a procedure for adjusting a general maintenance schedule when interference occurs due to a request of a mobile terminal during maintenance according to an embodiment of the present invention.

Referring to FIG. 6, the device management apparatus 100 transmits a maintenance start signal to a predetermined electronic device 400 in step 610. A maintenance package may also be transmitted in a streaming scheme. The maintenance start signal instructs the electronic device 400 to start the maintenance.

In step 615, the electronic device 400 starts maintenance according to the maintenance start signal. While maintenance in the electronic device 400 is in progress, the mobile terminal 200 may transmit user input for driving the electronic device 400, i.e., a power-on request signal, to the device management apparatus 100 in step 620. In this case, the device management apparatus 100 determines whether the power-on request signal is a maintenance interference signal. If the device management apparatus 100 determines that the power-on signal is a maintenance interference signal, the electronic device 400 should stop the maintenance for processing the power-on request signal. For example, if a power-on request signal of a television is generated when overall use of the television is impossible, because the maintenance includes an Operating System (OS) of the television being updated, the device management apparatus 100 recognizes the power-on request signal as a maintenance interference signal. However, if it is determined that a received command signal is not a maintenance interference signal, the device management apparatus 100 simultaneously controls the maintenance and functions according to the command signal to be executed. Of course, the user input is not limited to a power-on request signal, and may include various function request signals.

In step 640, when it is determined that the received command signal is a maintenance interference signal, the device management apparatus 100 transmits a maintenance pause signal and an electronic power-on signal to the electronic device 400 in step 640. Accordingly, the electronic device 400 stops the maintenance and power itself on in step 645.

Accordingly, when the user wants to use the electronic device 400 while maintenance of the electronic device 400 is in progress, the device management apparatus 100 stops the maintenance, if necessary, and allows the electronic device 400 to be used.

In step 650, the mobile terminal 200 transmits a power-off request signal to the device management apparatus 100 to terminate use of the electronic device 400. Here, the device management apparatus 100 recognizes the power-off signal as a maintenance interference release signal. In step 655, the device management apparatus 100 determines a maintenance progress state of an electronic device 400 and adjusts a general maintenance schedule. For example, the device management apparatus 100 may request the electronic device 400 or recognize a maintenance progress state based on a transmission amount of a maintenance package being transmitted.

In step 660, the device management apparatus 100 transmits a power-off signal to the electronic device 400, and accordingly, power of the electronic device 400 is turned-off in step 665.

In step 670, the device management apparatus 100 transmits a maintenance restart signal to the electronic device 400 according to an adjusted schedule, and the electric device 400 restarts the maintenance in step 675.

When adjusting a maintenance schedule in step 655, the device management apparatus 100 may adjust a maintenance schedule such that the stopped maintenance restarts upon sensing a maintenance interference release signal, or such that remaining maintenance restarts according to a driving pattern of the electronic device 400.

When a maintenance execution time is re-planned such that maintenance directly restarts after maintenance interference release signal, step 660 and step 670 may be simultaneously performed.

As described above, the device management apparatus 100 adjusts a general maintenance schedule after termination of using the electronic device 400, such that the maintenance is performed at a different than initially planned. Accordingly, the device management apparatus 100 may adjust a general maintenance schedule according to a user's use of the electronic device 400. Accordingly, the present invention may adjust a maintenance execution time without hindering the use of the electronic device 400.

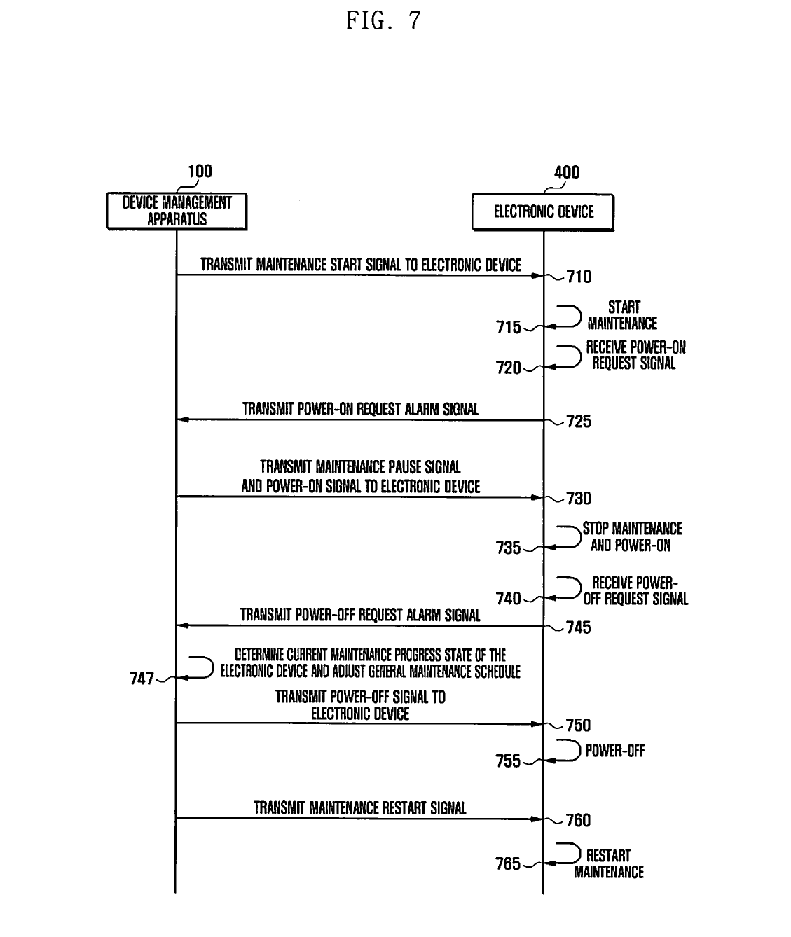

FIG. 7 is a signal flow diagram illustrating a procedure for adjusting a general maintenance schedule when interference is detected from a remote controller or an input unit in an electronic device during maintenance according to an embodiment of the present invention.

Referring to FIG. 7, the device management apparatus 100 transmits a maintenance start signal to an electronic device 400 in step 710, and the electronic device 400 starts the maintenance in step 715. If a power-on request signal is received through a remote controller or an input unit when the maintenance is in progress in step 720, the electronic 400 transmits a power-on request alarm signal to the device management apparatus 100 in step 725.

In step 730, the device management apparatus 100 transmits a maintenance pause stop signal and a power-on signal to the electronic device 400. The electronic device 400 stops the maintenance and turns power on in step 735.

In step 740, the electronic device 400 receives a power-off signal for finishing use of the electronic device 400 from the device management apparatus 100, and then transmits a power-off request alarm signal to the device management apparatus 100 in step 745.

When the power-off request alarm signal is received, the device management apparatus 100 determines a maintenance progress state of the electronic device 400, and adjusts a general maintenance schedule in step 747. Thereafter, the device management apparatus 100 transmits the power-off signal to the electronic device 400 in step 750.

In step 755, power of the electronic device 400 is turned-off.

In step 760, the device management apparatus 100 transmits a maintenance restart signal to the electronic device 400 according to an adjusted schedule. Thereafter, the electronic device 400 restarts the maintenance in step 765.

As described above, when interference occurs in the electronic device 400, a maintenance execution schedule is adjusted.

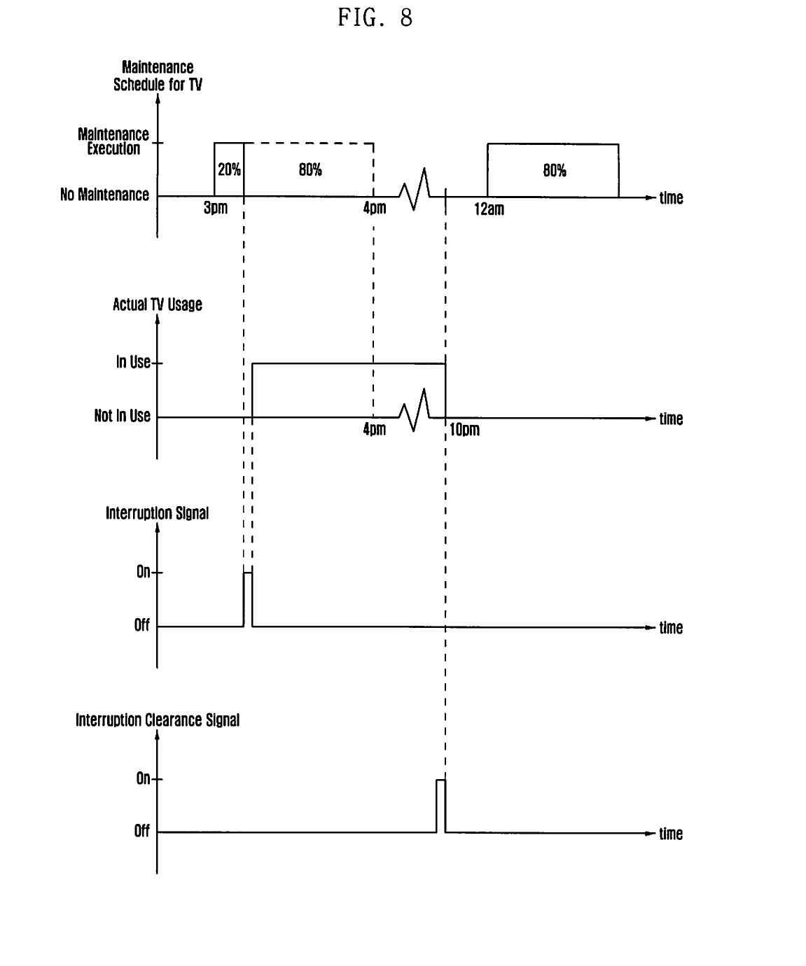

FIG. 8 is a timing chart illustrating a general maintenance schedule, an actual used time of a television, an interference signal, and an interference release signal for a television indicating an example of adjusting a general maintenance schedule during interference of maintenance according to an embodiment of the present invention.

Referring to FIG. 8, maintenance, for example, a software update, of the television is planned from 3 p.m. to 4 p.m. Referring to a timing chart of an interference signal (an interruption signal) in the mobile terminal 200 or the television is sensed by the device management apparatus 100 after performing 20% of the software update. When receiving an interference signal, for example, a power-on signal or various function request signals, the device management apparatus 100 may transmit a software update stop signal to the television to pause software update.

The mobile terminal 200 or the television transmits, for example, a power-off request signal to the device management apparatus 100, the device management apparatus 100 controls the power of the television to be turned-off. In addition, the device management apparatus 100 recognizes a maintenance progress state to adjust a general maintenance schedule. In this case, the device management apparatus 100 determines that a power-off request signal is an interference release signal, calculates a remaining required maintenance time, and re-plans a maintenance execution time such that remaining maintenance can be performed.

For example, the device management apparatus 100 recognizes that current software update is 20% done, and accordingly, determines that a required time for the remaining software update is 48 minutes (e.g., 80% of one hour). Further, the device management apparatus 100 confirms a possible maintenance time from a driving pattern of a television of FIG. 4 to recognize a time interval when the remaining 80% may be continuously updated. For example, if the possible maintenance time of a television is from 12 a.m. to 6 a.m., the device management apparatus 100 schedules the software update to restart at 12 a.m. When the maintenance package stop while being transmitted in a streaming scheme, the device management apparatus 100 may control such that the maintenance package is transmitted from a center part of a transmission.

After power of a television is turned-off, the device management apparatus 100 may adjust a maintenance execution time such that update of software directly restarts, such that the device management apparatus 100 simultaneously transmits a power-off signal and a software update restart signal to the television.

Accordingly, when a re-planned maintenance execution time comes, the device management apparatus 100 may transmit a maintenance restart signal to the electronic device 400, where the maintenance restart signal controls the maintenance to start and designates a start point indicating that the maintenance should start from any point.

Further, after the general maintenance schedule is adjusted, the device management apparatus 100 may transmit a software update restart signal to a television at a re-planned software update execution time. Accordingly, the television may complete any remaining maintenance.

Although FIG. 8 illustrates that the update of the software continues from a stopped part, the maintenance may also be able to be performed from the beginning. In this case, the device management apparatus 100 may display a pop-up window informing the user that maintenance is in progress, and asking whether the user wants to use the electronic device 400 immediately or after completion of the maintenance. If the user selects use of the electronic device 400 immediately, the device management apparatus 100 may adjust an execution schedule in consideration of a required maintenance time, which should start from the beginning.

As described above, in accordance with an embodiment of the present invention, a general maintenance schedule may be adjusted to stop maintenance, if the user wants to use the electronic device 400.

In addition, the present invention may remotely support a software version to be managed during maintenance. The management of a software version secures hardware restriction of electronic devices 400, and may be executed by storing software update versions for each electronic device 400 by the device management apparatus 100.

For example, the user may check a software version list through a GUI of the device management apparatus 100 or a mobile terminal 200. If a version for restoration is selected from the list, a version restoration request signal is transferred to the device management apparatus 100 to be restored to a selected version. Here, the version restoration request signal may include identification of a version to be restored.

In response, the device management apparatus 100 may control a corresponding electronic device 400 to restore the software to a requested version. Specifically, if a version selected from a version restoration request signal is confirmed, the device management apparatus 100 may transmit version restoration data corresponding to the confirmed version and a version restoration command signal to a corresponding electronic device 400. Here, the version restoration data may be an update package of a version corresponding to the confirmed version or update history information according to a scheme updated with a current software version.

The device management apparatus 100 may search an update package of a confirmed version with reference to version information of update packages. The version information may be stored with an update package. The update history information includes at least one of identification and file change content of a file for restoring a current software version to a confirmed version and a file to be deleted.

As described above, a device management apparatus 100 in accordance with an embodiment of the present invention is advantageous that it integrally manages maintenance of a plurality of electronic devices 400 connected through a network from maintenance schedule management to software version management.

An integral maintenance management function performed by a device management apparatus 100 may be performed in a maintenance server 300 and a mobile terminal 200 in a device management system. That is, the maintenance server 300 or the mobile terminal 200 may support generation and adjustment functions of a general maintenance schedule, and a software version management function. Further, the maintenance server 300 or the mobile terminal 200 may transfer a control signal for managing the maintenance to a corresponding electronic device 400 through a device management apparatus 100 to provide an integral maintenance management function.

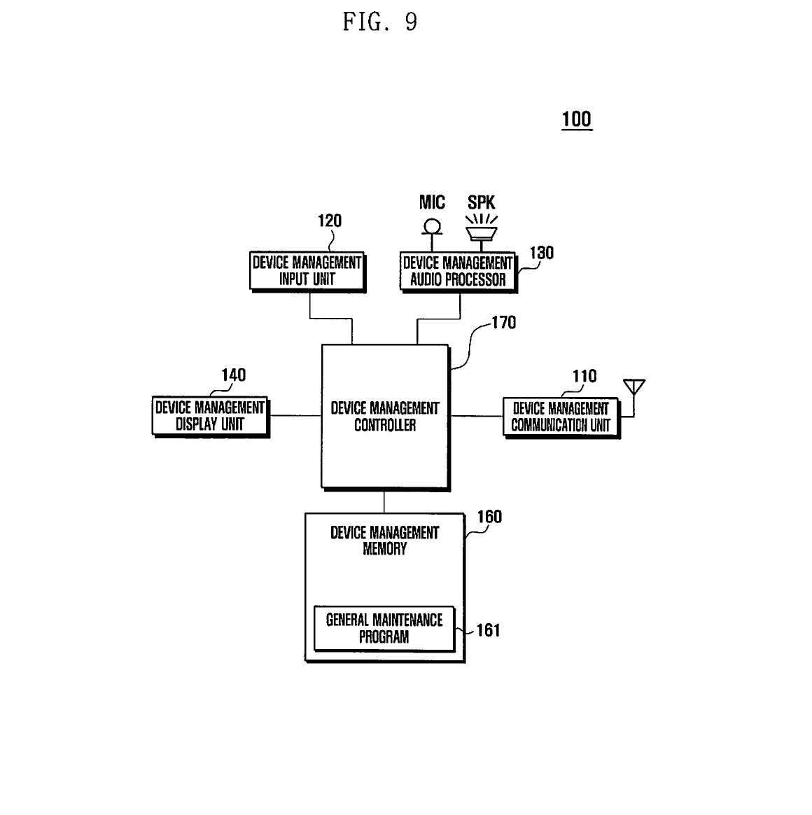

FIG. 9 is a block diagram illustrating a device management apparatus according to an embodiment of the present invention.

Referring to FIG. 9, the device management apparatus 100 includes a device management communication unit 110, a device management input unit 120, a device management audio processor 130, a device management display unit 140, a device management memory 160, and a device management controller 170.

The device management communication unit 110 forms a wired/wireless communication channel (referred to as a “data communication channel”) for transmission/reception of data such as a control signal or a data package under the control of the device management controller 170. Particularly, the device management communication unit 110 forms a wired/wireless communication channel for communicating with a mobile terminal 200, a maintenance server 300, and a plurality of electronic devices 400 in the device management system, according to an embodiment of the present invention.

The device management communication unit 110 transmits data for integral management of maintenance between structural elements of the device management system 100 under the control of the device management controller 170 through a data communication channel. For example, the device management communication unit 110 may receive a maintenance package from a maintenance server 300, transmit a maintenance control signal, such as maintenance start, stop, and restart, receive a maintenance interference signal and an interference release signal from the electronic device 400, transfer the maintenance interference signal and the interference release signal to the device management controller 170, and transmit version restoration data and a version restoration command signal to an electronic device 400.

Accordingly, the device management communication unit 110 supports formation of a communication channel according to at least one module and scheme. For example, the device management communication unit 110 may include a wireless communication unit for forming a communication channel with the maintenance server 300. Further, to form a communication channel with electronic devices 400, the device management communication unit 110 may include a wired communication modem or a wireless communication modem, and support various communication schemes. For example, the device management communication unit 110 may support a DLNA standard scheme. Further, the device management communication unit 110 may communicate with electronic devices 400 using ZigBee, Z-Wave, a wireless Personal Area Network (PAN), a Wireless Local Area Network (WLAN), or an Ethernet.

The device management input unit 120 includes various input devices for receiving numerals or character information, and setting various functions. For example, the device management input unit 120 may include a plurality of input keys, function keys, a touch panel, etc. Particularly, a device management input unit 120 generates and transfer a mode setting signal for setting a general maintenance management mode to the device management controller 170. Accordingly, the device management controller 170 supports a general maintenance schedule to be generated when receiving maintenance according to a received mode setting signal.

Further, the device management input unit 110 generates and transmits a state confirmation request signal for confirming current maintenance states of electronic devices to the device management controller 170. The device management input unit 120 generates and transfers a version return request signal for restoring a version to a desired software version from the user to the device management controller 170.

The device management audio processor 130 includes a speaker (SPK) for playing audio data according to selection of various execution modes or functions of the device management apparatus 100 and a microphone (MIC) for collecting a voice of the user to set an execution mode or to perform a function. The device management audio processor 130 outputs a corresponding effect sound when a maintenance interference signal informing generation or update of a general maintenance schedule, or change in a maintenance execution time, and an interference release signal is received. When a software version restoration request is received, the device management audio processor 130 outputs a corresponding effect sound. The foregoing effect sounds may be omitted by user setting.

The device management display unit 140 displays information input by the user, information provided to the user, and various menus of the device management apparatus 100. That is, the display unit 140 provides a situation alarm screen informing a maintenance management state and a version information screen supporting such that the version may be restored to a certain version, when a current software version is requested to be informed and a version list is requested to be provided at the request time.

The device management memory 160 stores at least one application program for a function operation of the device management apparatus 100 according to an embodiment of the present invention, user data created by the user, messages transmitted/received in the device management system 10, and data according to execution of the application program. The device management memory 160 includes a program area and a data area.

The program area stores an OS for booting the device management apparatus 100 and for operating the foregoing structural elements, and an application program for controlling the electronic devices 400. In particular, the program area of the present invention may further store a general maintenance program 161.

The general maintenance program 161 includes routines for generating a general maintenance schedule to integrally manage the maintenance as a plurality of maintenance packages are received by a device management apparatus 100 from a maintenance server 300.

The general maintenance program 161 may include a routine for acquiring maintenance packages, a schedule routine for processing the maintenance packages to generate a general maintenance schedule, and an execution routine for managing such that the maintenance is executed. Further, a software version restoration of a user with respect to an electronic device 400 is requested, the general maintenance program 161 controls the electronic device 400 to restore software to a requested version.

The package acquiring routine is programmed such that the device management apparatus 100 acquires the maintenance packages through a data communication channel formed between the maintenance server 300 and the device management apparatus 100 by pushing the maintenance server 300 or the control of the device management controller 170.

If a preset number of maintenance packages are received, the schedule routine may be set. When acquiring a plurality of maintenance packages, the schedule routine may be programmed such that the packages are processed to generate a general maintenance schedule.

Specifically, the schedule routine may be set such that a possible maintenance time is determined for each of the plurality of maintenance packages. Here, the schedule routine determines an electronic device corresponding to each package, and recognizes a driving pattern of a corresponding electronic device, and sets such that a required maintenance time of a corresponding maintenance electronic device is calculated. Further, the schedule routine may be programmed such that the device management apparatus 100 determines a possible maintenance time with reference to a recognized driving pattern and the calculated and required maintenance time. The schedule routine may be set such that possible maintenance times of a plurality of maintenance packages are combined to generate a general maintenance schedule.

When the device management apparatus 100 detects a maintenance interference signal while the maintenance is being executed in the electronic device 400, the schedule routine may be programmed such that a general maintenance schedule is adjusted. When an interference release signal is detected according to setting, the schedule routine may directly restart the maintenance or be programmed to restart according to a driving pattern with reference to remaining maintenance times and a possible maintenance time.

As described above, the execution routine is executed after generation of the general maintenance schedule. In particular, the execution routine manages such that the maintenance is executed in the electronic devices 400 according to the general maintenance schedule. Here, the execution routine may be set such that the maintenance package and a maintenance restart signal are transferred to at least one corresponding electronic device 400 according to the general maintenance schedule. Further, when an interference signal is detected, the execution routine may be set such that a maintenance stop signal is transferred to a corresponding electronic device 400.

When an interference release signal is detected, an execution routine may be set such that a maintenance restart signal is transferred to at least one corresponding electronic device 400 according to a general maintenance schedule adjusted due to an interference signal.

When the version return request signal is detected, the version restoration routine confirms version information of a software version restoration requested from the version restoration request signal and is programmed such that version restoration data corresponding to the confirmed version information and an installation control signal are transmitted.

The memory 160 includes the foregoing program area and also a data area. The data area of the memory 160 is for storing data created according to the use of the device management apparatus 100. Particularly, the data area of the present invention stores information used or created during execution of the general maintenance program 161. For example, the data area may store an electronic device database. The electronic database includes identification information and driving patterns of electronic devices included in the device management system. In addition, the electronic device database includes a current driving state, version information, or maintenance state information, such as a maintenance history of a currently installed package.

Further, the data area may store a package database. The package database includes a maintenance package, identification of the maintenance package, a type of maintenance work, identification information, and a required maintenance time of a corresponding electronic device 400. When the received package is for updating software, the package database may further store version information of the software. Further, the data area stores a general maintenance schedule with respect to electronic devices 400. That is, the data area stores a list of maintenance execution times of electronic devices 400 scheduled separately or by groups.

Accordingly, the general maintenance schedule includes identification information and maintenance execution time of corresponding electronic device(s) 400 whose maintenance is scheduled, and identification information of maintenance package(s). Accordingly, the device management apparatus 100 may determine which maintenance control signal it should send to any electronic device(s) 400 in any time point with reference to a general maintenance schedule.

The device management controller 170 controls an overall operation of the device management apparatus 100. Particularly, the device management controller 170 of the present invention may control an operation associated with an integral maintenance management function operation of electronic devices 400 in the device management system. For example, the device management controller 170 generates a general maintenance schedule from driving patterns of a plurality of packages and the electronic devices 400 acquired from the maintenance server 300, and supports a maintenance control signal to be transmitted to a corresponding electronic device 400. In addition, the device management controller 170 may support such that software of the electronic device 400 is restored to a certain version according to the request.

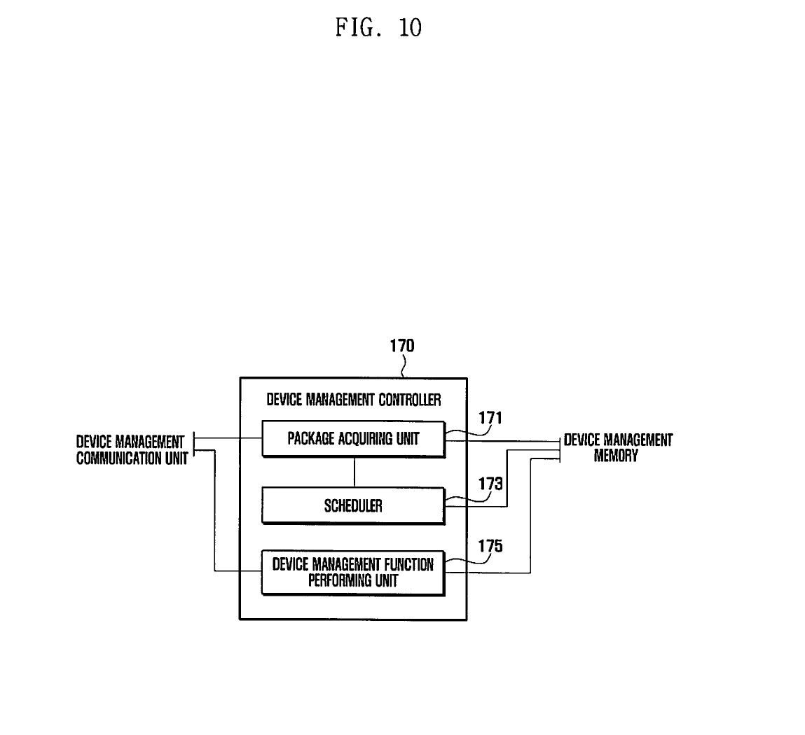

FIG. 10 is a block diagram illustrating a controller of a device management apparatus according to an embodiment of the present invention.

Referring to FIG. 10, the device management controller 170 includes a package acquiring unit 171, a scheduler 173, and a device management function performing unit 175. The package acquiring unit 171 supports communication of maintenance packages for a plurality of electronic devices 400. In particular, the package acquiring unit 171 controls the device management to acquire a plurality of maintenance packages from the maintenance server 300. In this case, the maintenance packages may be transmitted from the maintenance server 300 in a push scheme or be acquired according to request of the device management apparatus 100. After acquiring the packages, the package acquiring unit 171 analyzes each of the packages to recognize an electronic device, a type of maintenance, and a required time. Further, the package acquiring unit 171 may store packages in the device management memory 160 together with analyzed information.

The scheduler 173 generates a general maintenance schedule according to a required maintenance time of maintenance packages and driving patterns of corresponding electronic devices 400. For example, the scheduler 173 may determine whether the maintenance package is acquired by the preset number and then access the memory 160 to recognize a required maintenance time of each of the maintenance packages, a corresponding electronic device, and a driving pattern of the corresponding electronic device. Subsequently, the scheduler 173 determines a possible maintenance execution time according to the required maintenance time and the driving pattern to plan maintenance execution times of corresponding electronic devices.

When the interference release signal is received, the scheduler 173 adjusts a general maintenance schedule of an electronic device 400 corresponding to the interference release signal. The scheduler 173 determines a current maintenance progress state of the electronic device 400 and requests the device management communication unit 110 or the electronic device 400 to determine or store a current maintenance progress state.

Further, the scheduler 173 calculates a remaining required maintenance time in consideration of the current maintenance progress state, re-plans a maintenance execution time according to the remaining required maintenance time and a driving pattern of an electronic device 400 to update a general maintenance schedule.

The device management function performing unit 175 supports various functions of the device management device 100 for managing electronic devices 400. Particularly, the device management function performing unit 175 supports a maintenance package and a maintenance start signal to be transmitted to the electronic devices 400 according to a general maintenance schedule.

More specifically, the device management function performing unit 175 recognizes a maintenance execution time, an electronic device 400, and a type of maintenance. When the maintenance execution time comes, the device management function performing unit 175 controls the device management communication unit 100 to transfer a maintenance start signal according to the type of maintenance to the electronic device 400. Further, the device management function performing unit 175 supports the maintenance package to be transmitted to a corresponding electronic device 400.

When the maintenance interference signal is received, the device management function performing unit 175 controls the device management communication unit 110 to transmit a maintenance stop signal to a corresponding electronic device 400.

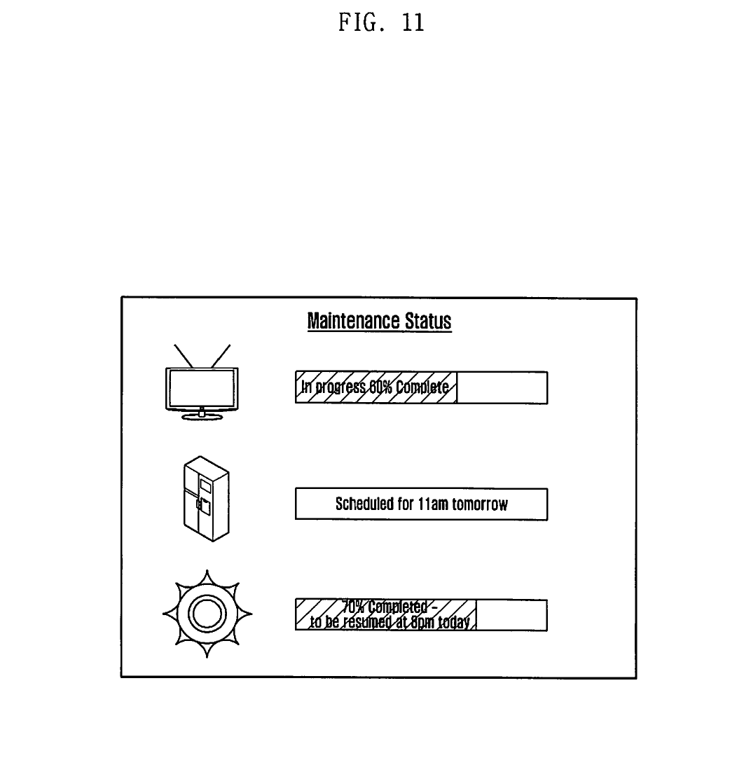

FIG. 11 illustrates a Graphic User Interface (GUI) for displaying a maintenance execution state according to an embodiment of the present invention.

As illustrated in FIG. 11, the device management function performing unit 175 controls the device management display unit 140 to output maintenance execution states of electronic devices 400 and accordingly inform the user of a current maintenance situation. The GUI may be also provided from electronic devices 400 or a mobile terminal 200.

Further, when an interference release signal is received, the device management function performing unit 175 accesses the memory 160 to confirm an adjusted maintenance execution time and a current maintenance execution state. When the adjusted maintenance execution time comes, the device management function performing unit 175 controls the device management communication unit 110 to transmit a maintenance restart signal to a corresponding electronic device 400. For example, the maintenance restart signal may instruct a restart point of the maintenance, or may instruct the maintenance to start from the beginning.

Further, the device management function performing unit 175 supports software of a corresponding electronic device 400 to be restored to a requested version according to a version restoration request of the user. When a version restoration request is received, the device management function performing unit 175 determines version information for restoration from the version restoration request. The device management function performing unit 175 then accesses the memory 160 and controls the device management communication unit 110 to transmit the version restoration data corresponding to determined version information and a version restoration command signal to the corresponding electronic device 400. In this case, the maintenance package and a package installation control signal may be transmitted simultaneously or sequentially.

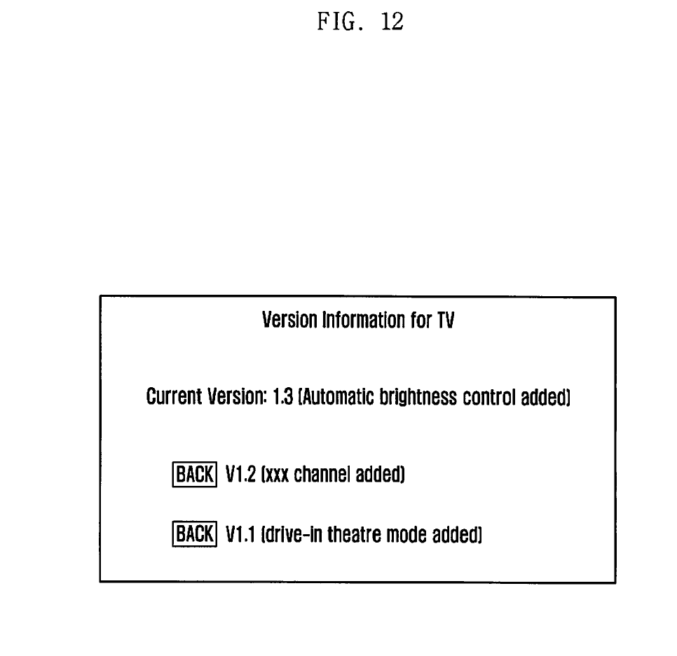

FIG. 12 illustrates a GUI for supporting a version restoration function according to an embodiment of the present invention.

Referring to FIG. 12, the device management function performing unit 175 displays the GUI on the device management display unit 140. Accordingly, the user may confirm a software version history and changed content by versions and the select a desired version for restoration. The GUI may also be displayed on the electronic devices 400 or the mobile terminal 200.

As described above, according to an embodiment of the present invention, maintenance of a corresponding electronic device 400 is started according to a general maintenance schedule to which a device use pattern in ordinary times. Specifically, a driving pattern is applied to execute a maintenance work without disturbing use of the electronic device 400. Further, the device management apparatus 100 may generate a management schedule suited to a used application of the electronic devices to minimize a disturbance probability of device use.

In addition, the device management apparatus 100 captures a moment when the user actually uses the electronic device 400 to adjust a general maintenance schedule, pausing the maintenance while the user uses the electronic device 400. Accordingly, the user may conveniently enjoy automatically maintained use of the electronic devices 400.

In addition, because the device management apparatus 100 of the present invention remotely manages maintenance of the electronic devices 400 memory use in each electronic device 400 for maintenance may be reduced.

Although certain embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims and their equivalents.

What is claimed is:

1. A method for integrally managing maintenance of a plurality of electronic devices by a device management apparatus, the method comprising:
acquiring, by the device management apparatus, a plurality of maintenance packages for the plurality of electronic devices;
generating a general maintenance schedule including at least one maintenance execution time with reference to the plurality of maintenance packages; and
upon arrival of the at least one maintenance execution time, transmitting a maintenance package and a maintenance control signal to a corresponding electronic device from among the plurality of electronic devices according to the general maintenance schedule.

2. The method of claim 1, wherein generating the general maintenance schedule comprises:
calculating driving patterns of the plurality of electronic devices corresponding to the plurality of maintenance packages and required maintenance times of the plurality of maintenance packages;
determining possible maintenance times based on the calculated driving patterns and the required maintenance times; and
generating the general maintenance schedule based on the possible maintenance times.

3. The method of claim 1, further comprising:
transmitting a maintenance pause signal to the corresponding electronic device, when a maintenance interference signal for using the corresponding electronic device is received during the maintenance;
determining a maintenance progress state, when an interference release signal is received;
adjusting the general maintenance schedule based on the maintenance progress state; and
transmitting a maintenance restart signal according to the adjusted general maintenance schedule.

4. The method of claim 3, wherein determining the maintenance progress state comprises:
calculating an amount of remaining maintenance;
calculating a remaining required maintenance time according to the amount of the remaining maintenance; and
determining another maintenance execution time with reference to the remaining required maintenance time and a driving pattern of the corresponding device.

5. The method of claim 1, further comprising:
storing a plurality of packages acquired together with package version information; and
transmitting version restoration data corresponding to a certain software version and a version restoration command signal, when a version restoration request signal to the certain software version is received.

6. The method of claim 5, wherein the version restoration data is update history information including a software update package or data to be restored.

7. A device management system comprising:
a server that stores maintenance packages;
a plurality of electronic devices that execute maintenance; and
a device management apparatus that acquires a plurality of maintenance packages with respect to the plurality of electronic devices from the server, generates a general maintenance schedule including at least one maintenance execution time with reference to the plurality of maintenance packages, and executes maintenance of an electronic device from among the plurality of electronic devices corresponding to the at least one maintenance execution time, when the at least one maintenance execution time arrives.

8. The device management system of claim 7, further comprising a mobile terminal communicating with the device management apparatus,
wherein one of the plurality of electronic devices or the mobile terminal transmits a maintenance interference signal for using a certain electronic device and an interference release signal informing use termination of the certain electronic device to the device management apparatus, and
wherein the device management apparatus transmits a maintenance pause signal to the certain electronic device in response to the maintenance interference signal, adjusts the schedule according to a maintenance progress state of the certain electronic device, when the interference release signal is received, and supports the maintenance in the certain electronic device to restart according to the adjusted schedule.

9. The device management system of claim 8, wherein one of the plurality of electronic devices or the mobile terminal transmits a version restoration request signal to a certain software version with respect to the one electronic device to the device management apparatus,
wherein the device management apparatus determines and stores package version information of the acquired maintenance packages, and transmits version restoration data corresponding to the certain software version and a version restoration command signal to the one electronic device with reference to the package version information, and
wherein the one electronic device executes restoration of the certain software version according to the version restoration data and the version restoration command signal.

10. The device management system of claim 7, wherein the device management apparatus divides the plurality of electronic devices into groups according to at least one of driving patterns, locations, and use application of the plurality of electronic devices, and recognizes a possible maintenance time specified in the groups to generate the schedule according to the groups.

11. A device management apparatus comprising:
a device management communication unit that acquires and transfers a plurality of maintenance packages with respect to a plurality of electronic devices;
a device management memory storing the plurality of maintenance packages; and
a device management controller generating a general maintenance schedule including at least one maintenance execution time with reference to the plurality of maintenance packages, and transmitting a maintenance package and a maintenance control signal to a corresponding electronic device from among the plurality of electronic devices according to the general maintenance schedule.

12. The device management apparatus of claim 11, wherein the controller confirms driving patterns of the plurality of electronic devices corresponding to the plurality of maintenance packages and required maintenance times of the plurality of maintenance packages, and plans the at least one maintenance execution time according to a possible maintenance time based on the driving patterns and the required maintenance times.

13. The device management apparatus of claim 11, wherein the controller controls the device management communication unit to transmit a maintenance pause signal to the corresponding electronic device, when a maintenance interference signal for using the corresponding electronic device is received during execution of the maintenance, determines a maintenance progress state to adjust the general maintenance schedule, when an interference release signal informing of termination of use of the corresponding electronic device is received, and transmits a maintenance restart signal according to the adjusted general maintenance schedule.

14. The device management apparatus of claim 13, wherein the controller calculates a remaining required maintenance time according to the maintenance progress state, determines another maintenance execution time with reference to the remaining required maintenance time and a driving pattern of the corresponding electronic device, and controls the device management communication unit to transmit the maintenance restart signal to the corresponding electronic device in the another determined maintenance execution time according to the adjusted general maintenance schedule.

15. The device management apparatus of claim 11, wherein the controller stores the plurality of packages in the device management memory with package version information, controls the device management communication unit to transmit version restoration data corresponding to the certain software version and a version restoration command signal to a corresponding electronic device with reference to the package version information.

16. The device management apparatus of claim 15, wherein the version restoration data is update history information including a software update package or data to be restored to the requested version.

17. A mobile terminal comprising:
a communication unit that communicates with a device management apparatus;
a display unit that displays a graphic user interface for integrally managing maintenance of a plurality of electronic devices connected to the device management apparatus; and
a controller that controls the device management communication unit to collect maintenance relation data with at least one of the plurality of electronic devices, and controls the display unit to display the maintenance relation data and the graphic user interface.

18. The mobile terminal of claim 17, wherein the user interface is displayed to provide a current maintenance state of the at least one electronic device, and to manage a software version of the at least electronic device.

19. The mobile terminal of claim 17, wherein the device management communication unit receives a maintenance package for updating a maintenance program of the mobile terminal from the device management apparatus, and the controller performs the update operation according to the maintenance control package.
